(19) United States
(12) Patent Application Publication
(10) Pub. No.: US 2024/0127180 A1
(43) Pub. Date: Apr. 18, 2024

(54) METHODS AND APPARATUS FOR LOGISTICS SUPPORT FOR LIFE CYCLE MANAGEMENT

(71) Applicant: Raytheon Company, Waltham, MA (US)

(72) Inventors: Fernando Alvarez, Tucson, AZ (US); Marcos Alejandro Ayon, Tucson, AZ (US); Daniel A. Colica, Tucson, AZ (US)

(73) Assignee: Raytheon Company, Waltham, MA (US)

(21) Appl. No.: 17/965,496

(22) Filed: Oct. 13, 2022

(51) Int. Cl. G06Q 10/08

(52) U.S. Cl. CPC G06Q 10/0875

(57) ABSTRACT

A computer implemented method and system for determining a change to an article of manufacture by analyzing Bills of Materials associated with the article for providing a corresponding change for the article in a Logistics Product Database which drives a corresponding change for the article in a Common Source Database. At least first and second Bill of Materials associated with the article are accessed wherein the first and second Bills of Materials are modeled by forming a respective block chain for each. A change of article data is detected by determining a difference of hash values regarding an aspect of the article when comparing the respective block chains of the first and second Bill of Materials. A notification is provided of a change to the article responsive to the detecting a change of article data.

### BACKGROUND

### 1. Field

The disclosed embodiments generally relates to logistics support systems and methods, and more particularly to synchronization of life cycle management data by determining changes to bills of materials.

### 2. Description of Related Art

Generally, a Product Lifecycle Management (PLM) system integrates data, processes, business systems, and people in an extended enterprise for managing product information throughout the entire product lifecycle efficiently and cost-effectively.

Integrated Logistics Support (ILS) is a process that facilitates the PLM of a product throughout its life cycle through the optimization of multiple product support-related performance parameters. A product supported by an integrated logistics support system may be any device or system, such as software, or an electrical, electro-mechanical, or mechanical product that may be designed by one or more development personnel and may be produced by the organization. The life cycle of the product may extend from inception phase to the serviceable life of the product and may include development and production phases. The design of the product may predominantly occur during the development phase of a life cycle. The production phase is entered into upon completion of the development phase and continues throughout the serviceable life of the product. A key component of ILS is a Bill of Materials (BOM).

A bill of materials is typically a list of items needed to manufacture an end item or final product. The bill of materials is used during the design of the end product. During the design, and product life, the list of items that is used in the design may change many times. A user often needs to compare different bills of materials from different but similar assemblies, or different revision dates for the same assembly to see what has changed.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with the exemplary illustrated embodiments described herein is an Integrated Logistics Support system configured and operably to readily detect change(s) in a Bill of Materials for a product, which detected changes are then automatically updated in a Logistics Product Database. The Logistics Product Database preferably drives those changes to a Common Source Database (CSDB) so as to preferably provide timely update of the detected changes to technical publications relating to the product. In accordance with an aspect of certain embodiments, detected products changes are preferably detected by modeling bills of materials in blockchains, which blockchains are compared to readily detected changes in the PLM for the product.

To achieve these and other advantages and in accordance with the purpose of the illustrated embodiments, in one aspect, described is a computer implemented method and system for determining a change to an article of manufacture by analyzing bills of materials associated with the article for providing a corresponding change for the article in a Logistics Product Database which drives a corresponding change for the article in a Common Source Database. At least first and second bill of materials associated with the article are accessed wherein the first and second bills of materials are modeled by forming a respective blockchain for each. A change of article data is detected by determining a difference of hash values regarding an aspect of the article when comparing the respective blockchains of the first and second bill of materials. A notification is provided of a change to the article responsive to the detecting a change of article data.

### BRIEF DESCRIPTION OF THE DRAWINGS

So that those skilled in the art to which the subject disclosure appertains will readily understand how to make and use the devices and methods of the subject disclosure without undue experimentation, illustrated embodiments thereof will be described in detail herein below with reference to certain figures, wherein:

FIG. 1 illustrates an exemplary communication network used with the illustrated embodiments described herein;

FIG. 2 illustrates an exemplary network device/node used with the illustrated embodiments described herein;

FIG. 3 illustrates a block diagram of one embodiment of an integrated logistics support system according to an illustrated embodiment; and

FIG. 4 is a flowchart showing several actions that may be performed in order to implement the illustrated embodiment of FIG. 3.

### DETAILED DESCRIPTION OF CERTAIN EMBODIMENTS

Aspects of the disclosed embodiments are illustrated in the following description and related drawings directed to specific illustrated embodiments. Alternate embodiments may be devised without departing from the scope of the illustrated embodiments. Additionally, well-known elements of the illustrated embodiments will not be described in detail or will be omitted so as not to obscure the relevant details of the illustrated embodiments.

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which the illustrated embodiments belong. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

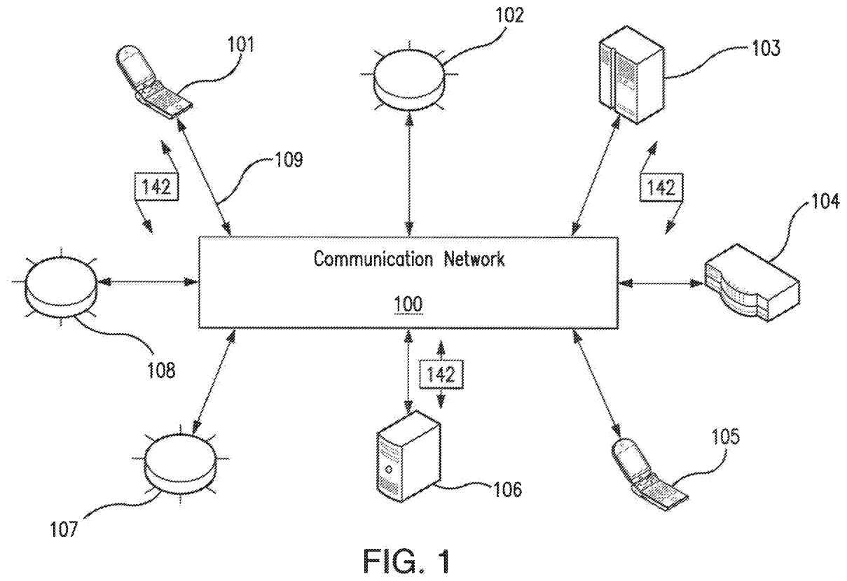

Turning now descriptively to the drawings, in which similar reference characters denote similar elements throughout the several views, FIG. 1 depicts an exemplary computer network 100 in which below illustrated embodiments may be implemented. It is to be understood a computer network 100 is a geographically distributed collection of nodes interconnected by communication links and segments for transporting data between end nodes, such as personal computers, workstations, smartphone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example network 100 illustratively comprising nodes/devices 101-108 (e.g., sensors 102, client computing devices 103, databases 104, smartphones 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object-oriented programming language such as Java, Smalltalk, C++, C# or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to embodiments of the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

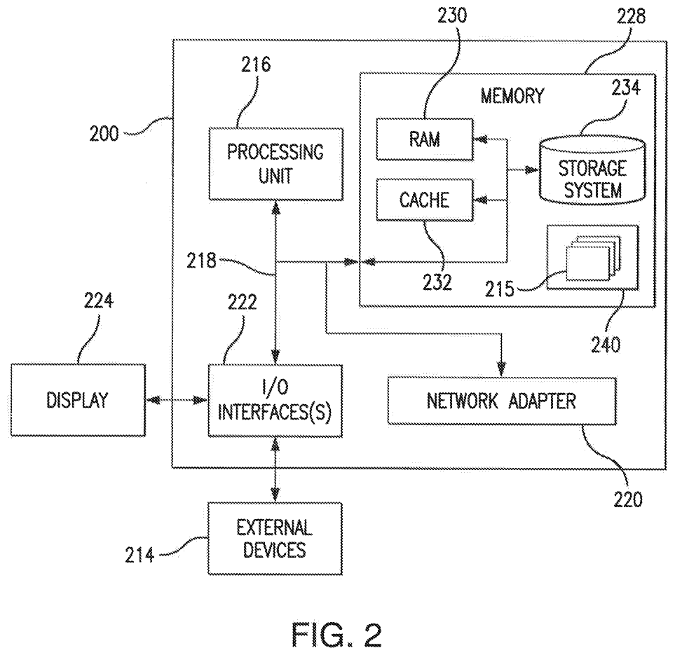

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein.

Computing device 200 is operational with special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 may include a variety of computer system readable media. Such media may be any available media that is accessible by device 200, and it includes both volatile and non-volatile media, removable and non-removable media. System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the illustrated embodiments.

Program/utility 240, having a set (at least one) of program modules 215, such as an XML Authoring Module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of illustrated embodiments described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described exemplary embodiments may be implemented. FIGS. 1 and 2 are exemplary of a suitable environment and are not intended to suggest any limitation as to the structure, scope of use, or functionality of the illustrated embodiments. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

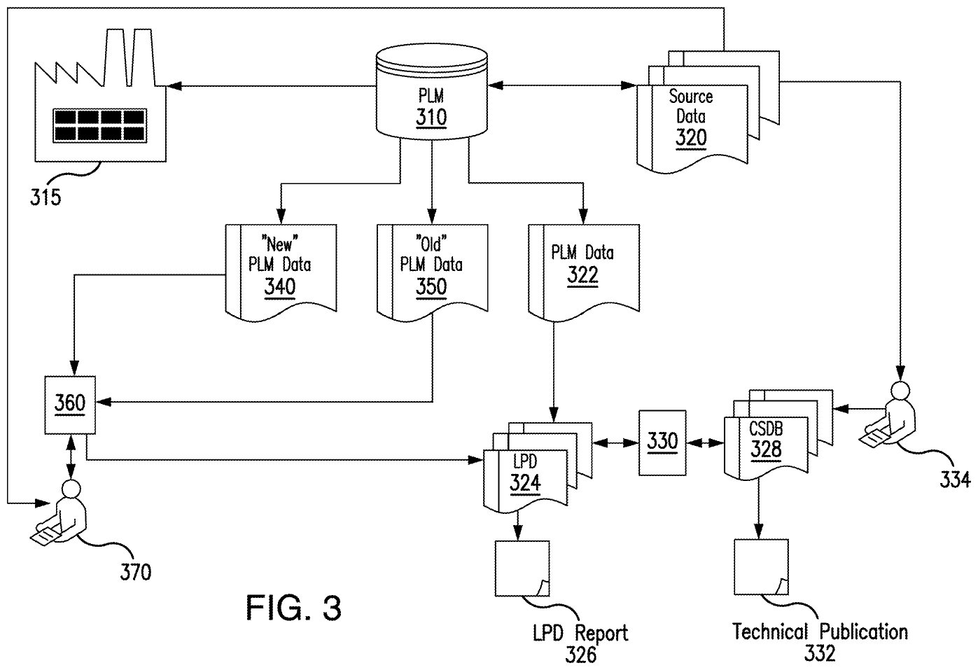

With the exemplary computer network 100 (FIG. 1) and computing device 200 (FIG. 2) being generally shown and discussed above, description of certain exemplary illustrated embodiments will now be provided. With reference now to FIG. 3, illustrated is an exemplary Integrated Logistics Support (ILS) system 300, which preferably utilizes one or more components of the system 100 of FIG. 1 and the device 200 of FIG. 2. It is to be appreciated that ILS's 300 have typically been used during the development phase of a product's life cycle in order to identify weaknesses in the design of the product. Once identified, modifications may have been made to the design of the product in order to enhance the general robustness of the product. These ILS's 300 may have included applications or tools, such as reliability, maintainability and/or testability (RMT) applications, and are generally associated with maintenance optimization (e.g., the various trade-offs, such as cost, availability and safety, between making component/product bulletproof versus “reliable enough and easy to fix”). These applications were generally mathematical modeling tools that produced anticipated integrity values for various portions of the product. These anticipated integrity values indicated the general robustness of the design of the product due to projected normal as well as abnormal use. Results from product integrity analysis applications have generally enabled development personnel to identify potential weaknesses in the product and make appropriate corrective action to the design of the product. As described below with reference to FIGS. 2 and 3, the ILS 300 is configured and operative to readily detect change(s) in Bills of Materials (BOMs) for a product, which detected changes are then automatically updated in a Logistics Product Database (LPD), which LPD is configured and operative to drive the aforesaid product changes to a Common Source Database (CSDB) so as to preferably provide timely update of the detected changes to technical publications relating to the product. In accordance with an aspect of certain embodiments, detected products changes are preferably detected by modelling BOMs in blockchains, which blockchains are compared to readily detected changes in the PLM for the product.

With specific reference now to FIG. 3, for exemplary purposes, shown is an ILS 300 communicatively coupled to PLM 310 data for a managing a lifecycle of a product in accordance with the illustrated embodiments. The PLM 310 data is preferably communicatively coupled to a production and/or sustainment facility for the product, as well as communicatively coupled to source data 320 relating to many aspects of a products lifecycle. It is to be appreciated that such source data 320 is often engineering drawings wherein one or more of the following items are derived from source data through analysis: logistics design requirements, reliability and maintainability, system safety, maintenance engineering, support and test equipment, training and training devices, manpower and skills, facilities, transportation, supply support, and parts packaging associated with the product.

In accordance with certain illustrated embodiments, initial PLM data 322 for a product is extracted from the PLM system 310 and inputted into a LPD 324 for the product. It is to be appreciated and understood that an exemplary LPD 324 is operative and configured to capture information related to logistics design requirements, reliability and maintainability, system safety, maintenance engineering, support and test equipment, training and training devices, manpower and skills, facilities, transportation, supply support, and/or parts packaging associated with product (e.g., an article of manufacture from production facility 315). Typically, such an LPD 324 is located in a structured and relational database. For instance, when developed in accordance with SAE GEIA-STD-0007, the LPD may be formatted into over 100 integrated tables/entities of information, interconnected and aligned to supporting Product Support Analysis (PSA) activities. The data in aggregate typically generates the logistics support products required to sustain a system or end item. For instance, some common uses of a LPD include: Maintenance Planning; Support and Test Equipment (S&TE); Supply Support; Manpower, Personnel & Training (MP&T); Facilities; and Reliability and Maintainability (R&M) associated with a product, which may be embodied in one or more LPD reports 326 generated by the LPD 324.

In ILS 300 of FIG. 3, the LPD 324 is communicatively coupled to a CSDB 328 wherein it is to be appreciated data of the LPD 324 is preferably populated and sync 330 with the CSDB 328 for creating and maintaining the CSDB 328. It is to be appreciated and understood the CSDB 328 is preferably an information database and management tool for all objects required to produce the technical publications 332 associated with a product. For instance the CSDB 328 is to be understood to support one or more of: the technical publication process for a product; quality assurance for a product; the exchange of data among partners, suppliers, and customers associated with a product; and the delivery of technical publications in various formats on various media associated with a product. Several different kinds of information objects may be stored in a CSDB 328, including, but not limited to: a) illustrations and multimedia associated with a data module (e.g., figures, videos, animations, 3-D objects, or audio files that can accompany and supplement the contents of a data module); b) comments providing a mechanism for users to report on errors or to suggest improvements to a data module for a product; c) a publication module operative to manage the preparation and/or publication, which for example may be an S1000D document (S1000D specifies the data structure of the information objects and the processes for a CSDB management tool); and d) data dispatch notes (DDNs) describing the contents of a delivery package (e.g., change package).

Thus, it is to be understood and appreciated that is highly advantageous that any changes in the PLM of a product are promptly reported in the CSDB 328 so as to be timely reported to all relevant technical authors 334, as well for updating all relevant technical publications 332 associated with the product. As described herein below, in accordance with the illustrated embodiments, the LPD 324 drives notices of such product changes to the CSDB 328.

It is to be understood and appreciated that changes in a product are often reflected in an engineering change which typically prompts a new Bill of Materials (BOM), in contrast to an “old” BOM (which does not encompass the aforesaid product change). In accordance with the illustrated embodiments, upon such a change event for a product, the new BOM 340, and the old BOM 350 are extracted from the PLM 310 system which are then sent to a comparator application module 360. The comparator application module 360 preferably detects the change(s) between the new 340 and old 350 BOM so as to determine and produce LPD changes for user review 370 based on the aforesaid product change(s). Whereupon the user review 370 preferably confirms changes to be applied to the LPD 324, which changes are then detected by the CSDB 328, via sync process 330, such that technical authors 334 are timely notified so as to initiate the updating of technical publications 332 associated with the product.

With regard to detecting changes between the new 340 and old 350 BOM, the comparator application module 360 preferably models the new 340 and old 350 BOM by forming a blockchain, preferably starting from the piece parts and working up, such as to assemblies incorporating the piece parts. In accordance with the illustrated embodiments, generated are hash functions for parent assemblies that are preferably a function of children's hash values. It is to be appreciated that this block chain methodology isolates the mutation of the hash values to a single subassembly, leaving sibling hashes undisturbed. It is noted this is particularly advantageous in that a processing advantage is gained by avoiding the processing of the identical subassemblies, indicated by their identical hash values between the new 340 and old 350 BOM model.

More particularly, with regards to forming blockchains for Bills of Materials, it is to be understood that in accordance with certain illustrated embodiments, the process for comparing “new” Bill of Materials (340) with “old” Bill of Materials (350) preferably includes providing an initial Bill of Materials (e.g., an “old” Bill of Materials 350) having an ordered indentured parts list form. A blockchain is then started for this initial Bill of Materials (e.g., an “old” Bill of Materials 350), wherein each part in the Bill of Materials is entered into the blockchain. As each part is entered, a hash value is calculated for the block, wherein subsequent hash values are each a function of the previous hash value and the defining characteristics of the current part (the last hash value can be used as a hash value for the entire Bill of Materials (350)). Preferably a “new” (updated) Bill of Materials (340) is provided and processed in the same way as the aforesaid “old” Bill of Materials (350), whereby changed parts and new parts will thus have different or new associated hash values. Thus, the differing upstream hash values affect the calculation of downstream hash values whereby the final hash value can be used to quickly determine whether the “old” (350) and “new” (340) Bills of Materials are identical. Intermediate hash values can be used to quickly locate the first divergence between the “old” (350) and “new” (340) Bill of Materials. It is thus to be appreciated that this blockchain methodology creates a common blockchain starting from the piece parts of an assembly and working “up” to the assembly, such that hash functions for parents need to hash all children's prior hashes which isolates the mutation of the hash values to a single subassembly, leaving sibling hashes undisturbed. This is particularly advantageous in that it mitigates processing of the identical subassemblies, indicated by their identical hash values.

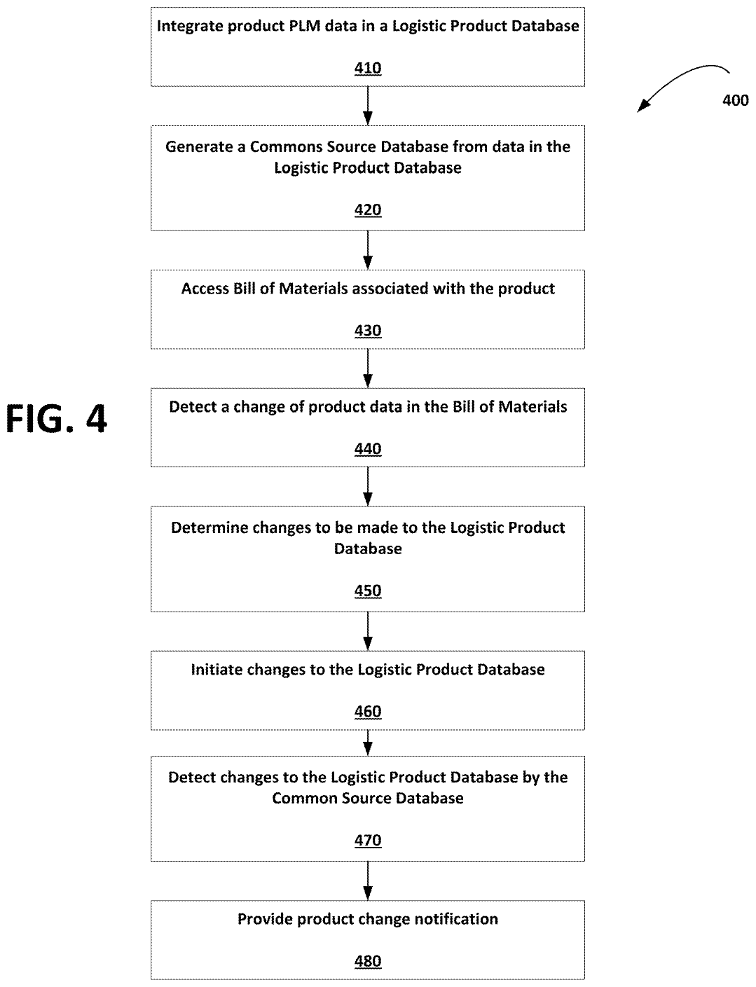

With certain aspects of the ILS system 300 being described above with reference to FIGS. 1-3, an exemplary method of operation relating to a process 400 for updating data in a Common Source Database (328) associated with a product (e.g., an article of manufacture) that is responsive to determining a change of data in a Bill of Materials (340, 350) for the product is illustrated in FIG. 4. Starting at step 410, product data is preferably integrated from a Product Lifecycle Management System (310) associated with the product into a Logistic Product Database (324). It is to be appreciated that the Logistic Product Database (324) preferably includes data related to one or more of: logistics design requirements, reliability and maintainability, system safety, maintenance engineering, support and test equipment, training and training devices, manpower and skills, facilities, transportation, supply support, and parts packaging associated with the product. It is to be further appreciated that the Product Lifecycle Management System (310) is preferably associated with the handling of the product as it moves through one or more of the following article stages: development and introduction, growth, maturity/stability, production and decline.

Next, at step 420, the Common Source Database (328) is preferably generated for the product based upon the product data present in the Logistics Product Database (324). As mentioned above, the Common Source Database (328) preferably includes electronic technical data and documentation relating to the PLM of the product utilized to generate and update technical publications (332) for the product.

With regards now to detecting changes in the PLM for the product, at step 430 a plurality of Bills of Materials associated with the product are preferably accessed from the PLM system (310) for detecting a change of product data in at least one “new” Bill of Materials (340) relative to at least one “old” Bill of Materials (350) from the plurality of Bills of Materials. For instance, such a change may include an engineering change to the product that is captured by the product data in a new Bill of Materials (340). As mentioned above, Bills of Materials for the product may include one or more of a plurality of assemblies and assembly parts utilized in the assemblies for the product.

At step 440, a change of product data is determined between the “new” Bill of Materials (340) relative to an “old” Bill of Materials (350) (preferably in the comparator module 360 of ILS 300), which in accordance with the illustrated embodiments is preferably accomplished by modelling the “new” Bill of Materials (340) and the “old” Bill of Materials (350) into respective blockchains, as mentioned and described above. A change of product data in the “new” Bill of Materials (340) relative to the “old” Bill of Materials (350) is detected by determining a difference of hash values in the respective blockchains regarding an aspect of the product when comparing the “new” 340 and “old” 350 Bills of Materials.

Once a change has been determined for the product by processing the aforesaid blockchains, preferably in the comparator module (360) (step 440), at step 450 one or more changes are determined, responsive to the detection of change of blockchain data in step 440, that are to be made to the Logistics Product Database (324) reflective of such product changes. Next, at step 460, one or more changes are made to the Logistics Product Database (324) responsive to the detection of logistics product data changes in step 450. In accordance with certain illustrated embodiments, notification may be provided to an interested user, such as for example a Logistic Support analyst, of such one or more product changes to the Logistic Product Database (324) responsive to detecting a change of article data (step 440), whereby the initiated changes to the Logistic Product Database (324) are confirmed by the interested user receiving the notification.

Next, at step 470, the Common Source Database (328) detects the aforesaid product changes to the Logistics Product Database (324), preferably via the data sync module 330. Once the Common Source Database (328) detects the aforesaid product changes to the Logistics Product Database (324), notification is preferably provided from the Common Source Database (328) to designated interested parties, such as technical authors (340), to affect update to the technical publications (332) associated with the product reflective of the aforesaid determined product changes.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer implemented method for updating data in a Common Source Database for an article responsive to determining a change of data in a Bill of Materials for the article, comprising:
integrating article data from a Product Lifecycle Management System associated with the article into a Logistic Product Database;
generating a Common Source Database (CSDB) for the article based upon the article data in the Logistics Product Database;
accessing a plurality of Bills of Materials (BOMs) associated with the article;
detecting a change of article data in at least a first Bill of Materials relative to a second Bill of Materials from the plurality of Bills of Materials;
determining one or more changes to be made to the Logistics Product Database responsive to detecting a change of article data;
initiating the determined one or more changes in the Logistics Product Database responsive to detecting a change of article data;
detecting the changes to the Logistics Product Database by the Common Source Database; and
providing notification from the Common Source Database responsive to the detected changes to the Logistics Product Database associated with the detected change of article data relative to at least the first and second Bills of Materials.

2. The computer implemented method as recited in claim 1, further including providing notification to a user of the determined one or more changes to be made to the Logistic Product Database responsive to detecting a change of article data, wherein the initiated changes to the Logistic Product Database are confirmed by the user receiving the notification.

3. The computer implemented method as recited in claim 2, wherein notification is provided to the Common Source Database indicating a change to the Logistic Product Database responsive to changes made to the Logistic Product Database that is responsive to detecting a change of article data.

4. The computer implemented method as recited in claim 1, wherein at least the first and second Bills of Materials are modeled by forming a respective blockchain.

5. The computer implemented method as recited in claim 4, wherein detecting a change of article data includes determining a difference of hash values regarding an aspect of the article when comparing the first and second Bills of Materials.

6. The computer implemented method as recited in claim 1, wherein a Bill of Materials associated with the article includes one or more of a plurality of assemblies and piece parts.

7. The computer implemented method as recited in claim 6, wherein the article is an article of manufacture.

8. The computer implemented method as recited in claim 7, wherein the first Bill of Materials is older relative to the second Bill of Materials.

9. The computer implemented method as recited in claim 8, wherein an engineering change to the article is captured by the article data in the second Bill of Materials.

10. The computer implemented method as recited in claim 9, wherein the Common Source Database includes electronic technical documentation relating to the article.

11. The computer implemented method as recited in claim 10, wherein the Logistic Product Database includes data related to one or more of: logistics design requirements, reliability and maintainability, system safety, maintenance engineering, support and test equipment, training and training devices, manpower and skills, facilities, transportation, supply support, and parts packaging associated with the article.

12. The computer method as recited in claim 1, wherein the Product Lifecycle Management System is associated with the handling of the article as it moves through one or more of the following article stages: development and introduction, growth, maturity/stability, production and decline.

13. A computer implemented method for determining a change to an article of manufacture by analyzing Bills of Materials associated with the article, comprising:
accessing at least a first and second Bill of Materials (BOM) associated with the article, wherein the first and second Bills of Materials are modeled by forming a respective blockchain;
detecting a change of article data by determining a difference of hash values regarding an aspect of the article when comparing the respective blockchains of the first and second Bill of Materials; and
providing notification of a change to the article responsive to the detecting a change of article data.

14. The computer implemented method as recited in claim 13, further including:
integrating article data from a Product Lifecycle Management System associated with the article into a Logistics Product Database;
generating a Common Source Database (CSDB) for the article based upon the article data in the Logistics Product Database;
determining one or more changes to be made to the Logistics Product Database responsive to the detecting a change of article data;
initiating the determined one or more changes in the Logistics Product Database responsive to the detecting a change of article data;
detecting the changes to the Logistics Product Database by the Common Source Database; and
providing notification from the Common Source Database responsive to the detected changes to the Logistic Product Database associated with the detected change of article data relative to at least the first and second Bill of Materials.

15. The computer implemented method as recited in claim 14, further including providing notification to a user of the determined one or more changes to be made to the Logistic Product Database responsive to detecting a change of article data.

16. The computer implemented method as recited in claim 15, wherein the initiated changes to the Logistic Product Database are confirmed by the user receiving the notification.

17. The computer implemented method as recited in claim 15, wherein notification is provided to the Common Source Database indicating a change to the Logistic Product Database responsive to changes made to the Logistic Product Database that is responsive to detecting a change of article data.

18. The computer implemented method as recited in claim 13, wherein a Bill of Materials associated with the article includes one or more of a plurality of assemblies and a plurality of piece parts.

19. A system for updating data in a Common Source Database for an article responsive to an engineering change, comprising:
at least one processing unit configured to:
integrate article data from a Product Lifecycle Management System associated with the article into a Logistic Product Database;
generate a Common Source Database (CSDB) for the article based upon the article data in the Logistics Product Database;
access, in response to the engineering change, a plurality of Bills of Materials (BOMs) associated with the article;
send at least a first Bill of Materials and a second Bill of Materials from the plurality of Bills of Materials to a comparator, the first Bill of Materials being older relative to the second Bill of Materials;
determine one or more changes to be made to the Logistics Product Database in response to the comparator reporting detection of a change of article data in at least the first Bill of Materials relative to the second Bill of Materials;
initiate the determined one or more changes in the Logistics Product Database;
detect the changes to the Logistics Product Database; and
provide a notification of the detected changes to the Logistics Product Database to technical authors.

20. The system of claim 19, wherein at least the first and second Bills of Materials are modeled by forming a respective blockchain whereby detecting a change of article data includes determining a difference of hash values regarding an aspect of the article when comparing the first and second Bills of Materials.
